(19) United States
(12) Patent Application Publication
(10) Pub. No.: US 2006/0234014 A1
(43) Pub. Date: Oct. 19, 2006

(54) Patterned adhesives for tamper evident feature

(76) Inventors: Yaoqi J. Liu, Shoreview, MN (US); Jeffrey H. Tokle, Scandia, MN (US); Kenneth J. Callahan, Shoreview, MN (US); Kevin R. Schaffer, Woodbury, MN (US)

Correspondence Address: 3M INNOVATIVE PROPERTIES COMPANY, PO BOX 33427, ST. PAUL, MN, 55133-3427, US

(21) Appl. No.: 11/105,968

(22) Filed: Apr. 14, 2005

(51) Int. Cl. B41M 5/00

(52) U.S. Cl. 428/195.1; 428/343

(57) ABSTRACT

An article is disclosed that includes a first substrate, and an adhesive layer disposed between on the first substrate. The adhesive layer includes a first adhesive region having a first adhesive and a second adhesive region having a second adhesive. The first adhesive is different from the second adhesive. The first adhesive region forms indicia. Methods of making and using the article are also disclosed.

### FIELD

This disclosure relates generally to tamper indicating articles and particularly to articles with patterned adhesives, wherein the adhesives have different properties and characteristics.

### BACKGROUND

Security laminates have been used to protect documents or packages to ensure that the underlying items are not altered. Security laminates are useful on identification cards such as driver's licenses and passports, and on other important documents such as certificates of title. Such laminates are also useful as protective labels on medications, videocassettes, and compact discs. Four features are useful when producing and using security laminates: (1) once applied to an article, the laminate is difficult to remove to ensure that the underlying item is not altered or subjected to tampering; (2) the laminate is difficult, if not impossible, to duplicate by counterfeiters; (3) an altered or counterfeit laminate can be quickly and accurately recognized if tampering occurs; and (4) manufacturing and application costs of the laminates are not prohibitively expensive.

Security laminates are constructed of various materials. In order to overcome the problem of counterfeit documents, manufacturers have endeavored to make it difficult for counterfeiters to duplicate a security laminate used on a particular document. Some constructions require special viewing devices to discern whether or not the laminate was subjected to tampering.

Multilayer film constructions containing intermediate layers having optical properties such as holograms or kinegrams are often used in security laminates. If the security laminate in these constructions is disturbed due to tampering, the holograms are destroyed. Tampering is therefore readily apparent when viewing the document with the naked eye. However, the film layer containing the holographic optical pattern is not transparent and can be expensive. These laminate constructions do not overcome all of the problems associated with security laminates because it is undesirable to cover an entire document or package with an opaque, expensive multilayer film. Further, it is necessary to properly register the opaque hologram on the document so as not to obscure any underlying data.

One relatively inexpensive laminate construction has been disclosed, where a document is laminated between two films with a pattern of adhesion-reducing coating either on the film or on the document before laminating. Once the layers are laminated, little or no bond exists in those places coated with the adhesion-reducing coating. Attempts to tamper with a document laminated with such a construction ordinarily result in destruction of the article to which the laminate is adhered. However, skilled tamperers are capable of removing the film without damaging the underlying article by using heat.

Tamper-proof multilayer films that are not transparent are also disclosed, wherein during attempts to tamper, the multilayer constructions are destroyed and both sides of the separated film layers display an originally concealed colored print. Tampering with these constructions is apparent to the unaided eye and the films are also impossible to laminate back together without visible damage. However, laminates having these constructions are not useful on identification documents because they are not transparent.

Other devices include constructions of a tamper-indicating labelstock or a security laminate comprising a transparent facestock, a release coating attached to one surface of the facestock for providing an indicia, a polymer coated on the facestock and release coating, a frangible metal layer and an adhesive layer. The labelstock is easily broken when tampering occurs that reveals the indicia printed by the release coating. Construction of this laminate requires a flood coating of primer over the release coating. Although this laminate might be use as a labelstock, such laminates often have relatively low durability and can split prematurely under everyday use. Further, this type of construction is susceptible to tampering because the construction is easily delaminated with heat.

### SUMMARY

This disclosure pertains generally to improved tamper evident articles, methods of making and methods of using the same. An article is disclosed that includes a first substrate and an adhesive layer disposed on the first substrate. The adhesive layer includes a first adhesive region having a first adhesive and a second adhesive region having a second adhesive. The first adhesive is different from the second adhesive. The first adhesive region forms indicia. In some embodiments, the first adhesive region includes a colorant. In some embodiments, a second substrate is disposed on the adhesive layer. In some embodiments, a release liner is disposed on to the adhesive layer.

Methods of making an article are also disclosed. One illustrative method includes disposing an adhesive layer on a first substrate. The adhesive layer includes a first adhesive region having a first adhesive and a second adhesive region having a second adhesive. The first adhesive is different from the second adhesive and the first adhesive region forms an indicia. In some embodiments, the first adhesive region includes a colorant. In some embodiments, the first adhesive region and second adhesive region can be formed by screen printing, or ink jet printing. In some embodiments, the adhesive regions can be cured.

Methods of using an article are also disclosed. One illustrative method includes providing an adhesive laminate including an adhesive layer disposed on a first substrate. The adhesive layer includes a first adhesive region having a first adhesive and a second adhesive region including a second adhesive. The first adhesive is different from the second adhesive and the first adhesive region forms an indicia. The method includes applying the adhesive laminate to a second substrate such that the adhesive layer is positioned between the first substrate and the second substrate. The method further includes separating at least a portion of the first substrate from at least a portion of the second substrate. The separating provides a tamper evident feature. In some embodiments, the first adhesive region includes a colorant.

The above summary of the present disclosure is not intended to describe each disclosed embodiment or every implementation of the present disclosure. The Figures, Detailed Description and Examples that follow more particularly exemplify these embodiments.

### BRIEF DESCRIPTION OF THE DRAWINGS

The disclosure may be more completely understood in consideration of the following detailed description of various embodiments of the disclosure in connection with the accompanying drawings, in which:

FIG. 1 is a sectional view of an article having a colored patterned adhesive layer which form indicia disposed between two substrates;

FIG. 2 is a front view of the article of FIG. 1;

FIG. 3 is a schematic sectional view of an embodiment of the article of FIG. 1 being separated;

FIG. 4 is a schematic sectional view of an embodiment of the article of FIG. 1 being separated;

FIG. 5 is a schematic sectional view of an embodiment of the article of FIG. 1 being separated; and

FIG. 6 is a schematic sectional view of an embodiment of the article of FIG. 1 being separated.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

Weight percent, percent by weight, % by weight, wt %, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”,“an”, and “the” encompass embodiments having plural referents, unless the content clearly dictates otherwise. For example, reference to “an adhesive” encompass embodiments having one, two or more adhesives. As used in this specification and the appended claims, the term “or” is generally employed in its sense including “and/or” unless the content clearly dictates otherwise.

The term “indicia” refers to numbers, letters, symbols, logos, and/or shapes which may convey information.

This disclosure relates to articles having a plurality of patterned adhesives having different properties and characteristics for applications such as, for example, security applications. The present disclosure implements two or more adhesives and patterns of the two or more adhesives. In particular, the two or more adhesives are patterned to form indicia optionally including one or more colorants. One aspect is for tamper evident effect, where a first substrate (e.g., label, tape or film) with a plurality of patterned adhesives having different adhesion properties and characteristics (and optionally having different colors) when peeled from a second substrate, leaves marks of the patterns on the first and/or second substrate. These effects will be described in more details below. These examples, and the examples discussed below, provide an appreciation of the applicability of the disclosed articles, but should not be interpreted in a limiting sense.

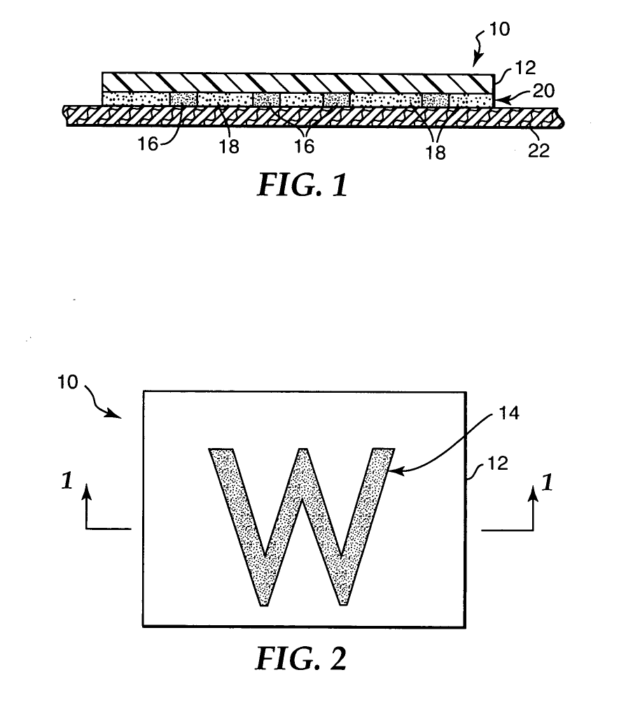

In FIG. 1, an article 10 includes an adhesive layer 20 disposed on a first substrate 12. The article can further include an optional second substrate 22 such that the adhesive layer 20 is positioned between the first substrate 12 and the second substrate 22. The adhesive layer 20 contains a first adhesive region 16 that includes a first adhesive. The adhesive layer 20 further contains a second adhesive region 18 that includes a second adhesive different from the first adhesive. In some embodiments, the second substrate 22 includes a paper material. In some embodiments, the first adhesive region 16 includes a first colorant. In further embodiments, the second adhesive region 18 includes a second colorant that is the same as, or different from, the first colorant disposed within the first adhesive region 16.

The first adhesive region 16 can form a pattern and/or indicia 14 that may be viewable through the first substrate 12 for at least some viewing and/or illumination geometries. In other embodiments, first adhesive region 16 can form a pattern and/or indicia 14 that is not viewable through the first substrate 12. In some embodiments, the indicia 14 is made up of or defined by at least the first adhesive region 16 and colorant. As shown in FIGS. 1-2, portion 16 and/or 18 are patterned in complementary fashion so as to define the indicia 14, which in this embodiment is a single letter “W”. Note that FIG. 1 corresponds roughly to a sectional view taken along axis 1-1 in FIG. 2, is drawn to a somewhat smaller scale than FIG. 1.

A release liner (not shown) can be disposed on the adhesive layer 20 prior to placing the adhesive layer 20 on the first substrate 12 and/or second substrate 22. In some embodiments, the adhesive layer can be formed on a release liner and then disposed on the first substrate. In other embodiments, the adhesive layer can be formed on a first substrate and the adhesive layer can be disposed on a release liner. The article can include a first substrate, an adhesive layer, and a release liner with the adhesive layer positioned between the first substrate and the release liner. The release liner can be removed prior to attachment of the adhesive layer to the second substrate.

Generally, a release liner includes a film capable of being placed in intimate contact with an adhesive and subsequently removed without damaging the adhesive layer. Non-limiting examples of release liners include materials from 3M of St. Paul, Minn. In some embodiments, a release liner is a polymer-coated paper with a silicone release coating, a polyethylene coated polyethylene terepthalate (PET) film with silicone release coatings, or a cast polyolefin film with a silicone release coating.

In FIG. 2, the indicia 14 is colored and the background is clear. In other embodiments, both the indicia 14 and background are colored with the background color being different than the indicia color. In still other embodiments, the background is colored and the indicia 14 is clear.

The adhesive layer 20, can be formed of any useful adhesives. In some embodiments, the adhesive layer 20 includes a pressure sensitive adhesive (PSA). In further embodiments, the adhesive layer 20 includes a heat-activated or curable adhesive. The adhesive layer 20 can have any useful thickness such as, for example, 5 to 500 micrometers, or 5 to 100 micrometers, or 10 to 50 micrometers.

A first class of materials useful for the adhesive includes acrylate and methacrylate polymers and copolymers. Such polymers are formed, for example, by polymerizing one or more monomeric acrylic or methacrylic esters of non-tertiary alkyl alcohols, with the alkyl groups having from 1 to about 20 carbon atoms (e.g., from 3 to 18 carbon atoms). Suitable acrylate monomers include, for example, methyl acrylate, ethyl acrylate, n-butyl acrylate, lauryl acrylate, 2-ethylhexyl acrylate, cyclohexyl acrylate, iso-octyl acrylate, octadecyl acrylate, nonyl acrylate, decyl acrylate, and dodecyl acrylate. The corresponding methacrylates are useful as well. Also useful are aromatic acrylates and methacrylates, e.g., benzyl acrylate. Optionally, one or more monoethylenically unsaturated co-monomers may be polymerized with the acrylate or methacrylate monomers. The particular type and amount of co-monomer is selected based upon the desired properties of the polymer.

One group of useful co-monomers includes those having a homopolymer glass transition temperature greater than the glass transition temperature of the (meth)acrylate homopolymer. As used herein, the term “(meth)acrylate” refers to an acrylate, methacrylate, or a combination thereof. Examples of suitable co-monomers falling within this group include acrylic acid, acrylamides, methacrylamides, substituted acrylamides (such as N,N-dimethyl acrylamide), itaconic acid, methacrylic acid, acrylonitrile, methacrylonitrile, vinyl acetate, N-vinyl pyrrolidone, isobornyl acrylate, cyano ethyl acrylate, N-vinylcaprolactam, maleic anhydride, hydroxyalkyl(meth) acrylates, N,N-dimethyl aminoethyl (meth)acrylate, N,N-diethylacrylamide, beta-carboxyethyl acrylate, vinyl esters of carboxylic acids (e.g., carboxylic acids such as neodecanoic, neononanoic, neopentanoic, 2-ethylhexanoic, propionic acids, or the like), vinylidene chloride, styrene, vinyl toluene, and alkyl vinyl ethers.

A second group of monoethylenically unsaturated co-monomers that may be polymerized with the acrylate or methacrylate monomers includes those having a homopolymer glass transition temperature (Tg) less than the glass transition temperature of the acrylate homopolymer. Examples of suitable co-monomers falling within this class include ethyloxyethoxy ethyl acrylate (Tg equal to −71 degrees Celsius) and a methoxypolyethylene glycol 400 acrylate (Tg equal to −65 degrees Celsius) such as material available under the trade designation NK ESTER AM-90G from Shin Nakamura Chemical Co., Ltd.

A second class of polymers useful in the adhesive includes semicrystalline polymer resins, such as polyolefins and polyolefin copolymers (e.g., polymer resins based upon monomers having 2 to 8 carbon atoms, such as low-density polyethylene, high-density polyethylene, polypropylene, ethylene-propylene copolymers, etc.), polyesters and co-polyesters, polyamides and co-polyamides, fluorinated homopolymers and copolymers, polyalkylene oxides (e.g., polyethylene oxide and polypropylene oxide), polyvinyl alcohol, ionomers (e.g., ethylene-methacrylic acid copolymers neutralized with a base), and cellulose acetate. Other examples of polymers in this class include substantially amorphous polymers such as polyacrylonitrile, polyvinyl chloride, thermoplastic polyurethanes, general epoxies such as aromatic epoxies and/or aliphatic epoxies, polycarbonates, amorphous polyesters, amorphous polyamides, acrylonitrile-butadiene-styrene (ABS) block copolymers, polyphenylene oxide alloys, ionomers (e.g., ethylene-methacrylic acid copolymers neutralized with salt), fluorinated elastomers, and polydimethyl siloxane.

A third class of polymers useful in the adhesive includes elastomers containing ultraviolet radiation-activatable groups. Examples include polybutadiene, polyisoprene, polychloroprene, random and block copolymers of styrene and dienes (e.g., SBR), and ethylene-propylene-diene monomer rubber. This class of polymer is typically combined with tackifying resins.

A fourth class of polymers useful in the adhesive includes pressure sensitive and hot melt applied adhesives prepared from non-photopolymerizable monomers. Such polymers can be adhesive polymers (i.e., polymers that are inherently adhesive), or polymers that are not inherently adhesive but are capable of forming adhesive compositions when compounded with components such as plasticizers, or tackifiers. Specific examples include poly-alpha-olefins (e.g., polyoctene, polyhexene, and atactic polypropylene), block copolymer-based adhesives, natural and synthetic rubbers, silicone adhesives, ethylene-vinyl acetate, and epoxy-containing structural adhesive blends (e.g., epoxy-acrylate and epoxy-polyester blends).

To increase cohesive strength of the adhesive, a crosslinking additive may be incorporated into the adhesive. Two main types of crosslinking additives are exemplary. The first crosslinking additive is a thermal crosslinking additive such as multifunctional aziridine, isocyanate and epoxy. One example of aziridine crosslinker is 1,1′-(1,3-phenylene dicarbonyl)-bis-(2-methylaziridine) (CAS No. 7652-64-4), referred to herein as “Bisamide.” Common polyfunctional isocyanate crosslinkers are trimethylolpropane toluene diisocyanate, toluene diisocyanate, and the like. Such chemical crosslinkers can be added into solvent-based adhesives after polymerization and activated by heat during oven drying of the coated adhesive. In another embodiment, chemical crosslinkers, which rely upon free radicals to carry out the crosslinking reaction, may be employed. Reagents such as, for example, peroxides serve as a source of free radicals. When heated sufficiently, these precursors will generate free radicals that bring about a crosslinking reaction of the polymer. A common free radical generating reagent is benzoyl peroxide. Free radical generators are required only in small quantities, but generally require higher temperatures to complete a crosslinking reaction than those required for the bisamide and isocyanate reagents.

The second type of crosslinking additive is a photosensitive crosslinker, which is activated by high intensity ultraviolet (UV) light. Two common photosensitive crosslinkers used for acrylic adhesives are benzophenone and copolymerizable aromatic ketone monomers as described in U.S. Pat. No. 4,737,559 (Kellen et al.). Another photocrosslinker, which can be post-added to the solution polymer and activated by UV light is a triazine, for example, 2,4-bis(trichloromethyl)-6-(4-methoxy-phenyl)-s-triazine. These crosslinkers are activated by UV light generated from sources such as medium pressure mercury lamps or a UV blacklight. Hydrolyzable, free-radically copolymerizable crosslinkers, such as monoethylenically unsaturated mono-, di-, and trialkoxy silane compounds including, but not limited to, methacryloxypropyltrimethoxysilane (available from Gelest, Inc., Tullytown, Pa.), vinyl dimethylethoxysilane, vinyl methyl diethoxysilane, vinyltriethoxysilane, vinyltrimethoxysilane, vinyltriphenoxysilane, and the like, are also useful crosslinking agents. Crosslinking may also be achieved using high energy electromagnetic radiation such as gamma or e-beam radiation. In this case, no crosslinker may be required.

The adhesive layer 20 can be formed by any useful method. In some embodiments, the adhesive layer 20 is formed by screen printing, or jet printing (e.g., ink jet printing), and the like. The first adhesive region 16 can be selectively formed by screen printing, jet printing (e.g., ink jet printing), and the like. The second adhesive region 18 can be selectively formed by screen printing, jet printing (e.g., ink jet printing), and the like.

In some embodiments, the adhesive layer 20 can be disposed directly onto the first substrate 12 surface by screen printing, jet printing (e.g., ink jet printing), and the like. In some of these embodiments, the second substrate 22 or release liner can be applied to the adhesive layer 12. In other embodiments, the adhesive layer 20 can be applied to the second substrate 22 or release liner by screen printing, jet printing (e.g., ink jet printing), and the like, and then the adhesive layer 20 can be disposed onto the first substrate 12. When present, the release liner can be removed and the adhesive layer 12 can be applied to the second substrate 22 to form the structure shown in FIG. 1.

In many embodiments, following the formation of the first adhesive region 16 and/or second adhesive region 18, the first adhesive region 16 and/or second adhesive region 18 can be cured with light or heat.

In some embodiments, the first adhesive region 16 and the second adhesive region 18 is selectively formed by jet printing. In some embodiments, the indicia 14 is selectively formed by jet printing. Useful adhesive compositions and devices for jet printing are described in U.S. Pat. Nos. 5,773,485 (Bennett et al.) and 6,513,897 (Tokie) and U.S. Publication No. 2002/0128340 (Young et al.), all incorporated by reference herein.

The adhesive layer 20 secures the article 10 to a second substrate 22. If desired, the second substrate 22 can form part of the article 10. Depending upon the intended use of the article 10, first substrate 12 and the second substrate 22 can itself comprise a wide variety of different transparent or opaque articles, such as a document, sheet of paper, rigid or flexible sign backing, or rigid or flexible window material. In many embodiments, first substrate 12 and the second substrate 22 are different. In one embodiment, the first substrate 12 includes a polymeric substrate and the second substrate 22 includes a paper substrate. In one embodiment, the first substrate 12 is a polymeric multilayer substrate and the second substrate 22 is a paper substrate. To the extent any light is transmitted through the combination of the first substrate 12 and indicia 14, such light can be absorbed, reflected diffusely or specularly, or transmitted by the second substrate 22.

The first adhesive region 16, as illustrated, is patterned to form the foreground of a letter “W”, and is disposed behind a first substrate 12. Other letters, symbols, or shapes which convey information are also contemplated. The first adhesive region 16 may include a colorant. In some embodiments, first adhesive region 16 includes a fluorescent colorant.

The term “colorant” refers to any pigment, dye, or other substance or combination of substances used to impart hue or chroma to an article. The term “fluorescent” refers to the property of emitting light at one wavelength (or band of wavelengths) as a result of the absorption of light at a different (and typically shorter) wavelength (or band of wavelengths). The wavelength range of emitted fluorescent light is referred to as an emission band; that of the absorbed light is referred to as an excitation band.

In addition to what has been described above, the complementary patterning adhesives have different adhesion properties, to provide tamper evident features. For example, if the first adhesive has stronger adhesion to a first substrate but weaker adhesion to a second substrate to be applied to, and the second adhesive has the opposite properties, when the first and second substrates 12 and 22 are peeled apart, the second adhesive will be partially or completely left on the second substrate while the first adhesive remains with the first substrate.

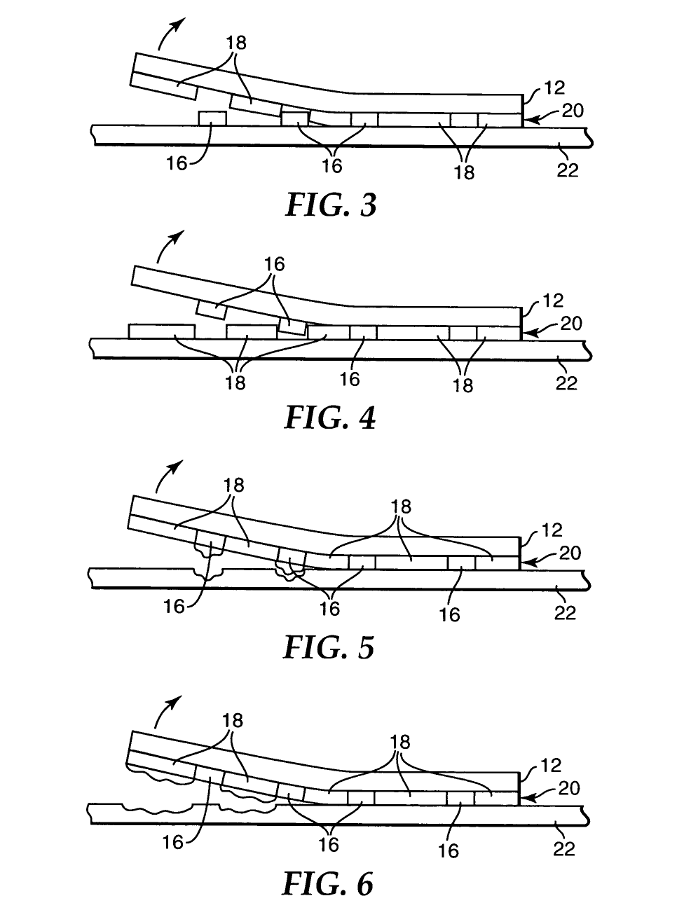

FIG. 3 through FIG. 6 are schematic sectional views of embodiments of the article of FIG. 1 being separated. In FIG.. 3 through FIG. 6, an article includes an adhesive layer 20 disposed between a first substrate 12 and a second substrate 22. The adhesive layer 20 includes a first adhesive region 16 that includes a first adhesive and a second adhesive region 18 that includes a second adhesive that is different from the first adhesive.

The first adhesive region 16 has a first substrate peel adhesion value and a second substrate peel adhesion value. The second adhesive region 18 has a first substrate peel adhesion value and a second substrate peel adhesion value. The first adhesive region peel adhesion values can differ from the second adhesive region peel adhesion values by a factor or 2, 3, 4, 5, 10, 20 or more times.

The adhesion value can be determined using a 180 degree peel adhesion test. This peel adhesion test is similar to the test method described in ASTM D 3330-90, substituting a glass substrate for the stainless steel substrate described in the test. The test can be performed by coating the adhesive on a substrate of interest. In some embodiments, the adhesive is coated on a polyester film. The substrate with the adhesive coating can be cut into 1.27 centimeter by 15 centimeter strips. Each strip can then be adhered to a 10 centimeter by 20 centimeter clean, solvent washed glass coupon using a 2-kilogram roller passed once over the strip. The bonded assembly can be dwelled at room temperature for about one minute and then tested for 180° peel adhesion using an IMASS slip/peel tester (Model 3M90, commercially available from Instrumentors Inc., Strongsville, Ohio) at a rate of 2.3 meters/minute (90 inches/minute) over a five second data collection time. Two samples are often tested; the reported peel adhesion value is an average of the peel adhesion value from each of the two samples.

In the embodiment illustrated in FIG. 3, upon separating the first substrate 12 from the second substrate 22, at least a portion of the first adhesive region 16 remains on the second substrate 22 and at least a portion the second adhesive region 18 remains on the first substrate 12, providing a tamper evident feature.

In the embodiment illustrated in FIG. 4, upon separating the first substrate 12 from the second substrate 22, at least a portion of the first adhesive region 16 remains on the first substrate 12 and at least a portion of the second adhesive region 18 remains on the second substrate 22, providing a tamper evident feature.

In the embodiment illustrated in FIG. 5, upon separating the first substrate 12 from the second substrate 22, at least a portion of the first adhesive region 16 and second adhesive region 18 remain on the first substrate 12 and at least a portion of the second substrate 22 adjacent to the first adhesive region 16 is removed from the second substrate 22, providing a tamper evident feature.

In the embodiment illustrated in FIG. 6, upon separating the first substrate 12 from the second substrate 22, at least a portion of the first adhesive region 16 and second adhesive region 18 remain on the first substrate 12 and at least a portion the second substrate 22 adjacent the second adhesive region 18 is removed from the second substrate 22, providing a tamper evident feature.

### EXAMPLES

Glossary of terms

| | |
|---|---|
| AA | Acrylic acid |
| 2-EHA | 2-Ethylhexyl acrylate |
| Irgacure 651 | 2,2-dimethoxy-1,2-diphenyl ethanone photoinitiator |
| | commercially available from Ciba Speciality |
| | Chemical Corp., Tarrytown, N.Y. |

### Example 1

Two adhesive monomer mixtures (Adhesive A and Adhesive B described below) can be coated onto a polymeric film (Radiant Light CM590 film available from 3M Company, St. Paul, Minn.) via inkjet coating (printing).

Adhesive A is a mixture of 2-EHA/AA in the weight ratio of 94/6 with 23 wt % SiO₂ added that has a 70/30 isooctylsilane/PEG2TES blend grafted to its surface, 0.3 wt % Irgacure 651 and optionally 8 wt % blaze orange dye AX-15-N (Lot #2520E available from Day-Glo Color Corporation).

“PEG2TES” refers to N-(3-triethoxysilylpropyl) methoxyethoxyethyl carbamate. It was prepared as follows: A 250 ml round-bottomed flask equipped with a magnetic stir bar was charged with diethylene glycol methyl ether (35 g) and methyl ethyl ketone (77 g). A majority of the solvent was removed via rotary evaporation to remove water. 3-(Triethoxysilyl)propylisocyanate (68.60 g) was charged to the flask. Dibutyltin dilaurate (3 mg) was added and the mixture stirred. The reaction proceeded with a mild exotherm. The reaction was run for approximately 16 hr at which time infrared spectroscopy showed no isocyanate. The remainder of the solvent and alcohol were removed via rotary evaporation (90° C.) to yield PEG2TES as a somewhat viscous fluid (104.46 g).

Adhesive B is a mixture of 2-EHA with 23 wt% SiO₂ added that has a 70/30 isooctylsilane/PEG2TES blend grafted to its surface, and 0.3 wt % Irgacure 651.

The inkjet coating (or jet printing) can be carried out as follows. An inkjet system, Solidjet by Trident, an ITW Company, could be used in conjunction with a motion control system and print data control system to deposit Adhesives A and B in respective patterns. The fluid supply system could consist of a reservoir in fluid communication with tubing, also in fluid communication with the Trident inkjet system. All fluidic retaining devices could be heated to control viscous properties of the adhesive materials. The inkjet printhead can be fully retractable to avoid collisions with the system's platen (substrate holder). Retractability can be pneumatic or electronic by use of a linear slide mechanism. The inkjet nozzle can be coupled to a linear slide mechanism like a Trilogy linear servo motor with 42″(1.1 meter) linear travel. The deposition velocity can be set to 3 in/s (230 mm/s) or more, or less. Any motion controller capable of controlling position and velocity can be used to control the motion. Typically, two axes are involved with printing operations to control both the print direction and the transverse or indexing directions. The motion control system triggers start of line pulses for the printhead control system to coordinate the begin of printing for each successive line of printed information—in this case adhesive A or B.

Adhesive A can be deposited in the indicia pattern, interstitial sites could be filled with Adhesive B. After each material is dispensed it is cured for 3 minutes at low intensity UV using Sylvania 350 BL lights in a nitrogen atmosphere.

The samples described above can be laminated to a piece of paper. When the sample is peeled from the paper, the indicia of Adhesive A should remain with the paper, or tear the paper while the non-indicia regions of Adhesive B will not tear the paper.

The disclosure should not be considered limited to the particular examples described above, but rather should be understood to cover all aspects of the disclosure as set out in the attached claims. Various modifications, equivalent processes, as well as numerous structures to which the disclosure can be applicable will be readily apparent to those of skill in the art upon review of the instant specification.

What is claimed:

1. An article comprising:
a first substrate; and
an adhesive layer disposed on the first substrate, the adhesive layer comprising a first adhesive region comprising a first adhesive and a second adhesive region comprising a second adhesive, wherein the first adhesive is different from the second adhesive and the first adhesive region forms an indicia.

2. An article according to claim 1 wherein the first adhesive comprises a first colorant.

3. An article according to claim 1 wherein the first adhesive has a first adhesion value to the first substrate and the second adhesive has a second adhesion value to the first substrate that is different from the first adhesion value.

4. An article according to claim 3 wherein the first adhesion value is different from the second adhesion value by a factor of 2.

5. An article according to claim 3 wherein the first adhesion value is different from the second adhesion value by a factor of 10.

6. An article according to claim 1 further comprising a release liner disposed on the adhesive layer.

7. An article according to claim 1 further comprising a second substrate disposed on the adhesive layer.

8. An article according to claim 7 wherein the first substrate is different from the second substrate.

9. An article according to claim 7 wherein first substrate comprises a polymeric multi-layer film and the second substrate comprises paper.

10. An article according to claim 1 wherein the indicia comprises a letter, a number, a logo, or a symbol.

11. An article according to claim 1 wherein the first adhesive comprises a first pressure sensitive adhesive and the second adhesive comprises a second pressure sensitive adhesive.

12. A method of making an article comprising a step of disposing an adhesive layer on a first substrate, the adhesive layer comprising a first adhesive region comprising a first adhesive and a second adhesive region comprising a second adhesive, wherein the first adhesive is different from the second adhesive and the first adhesive region forms an indicia.

13. A method according to claim 12 further comprising applying the adhesive layer on a release liner before the disposing step.

14. A method according to claim 12 further comprising applying a release liner on the adhesive layer.

15. A method according to claim 13 further comprising removing the release liner from the adhesive layer and applying the adhesive layer to a second substrate, the second substrate being different from the first substrate.

16. A method according to claim 12 wherein the disposing step comprises disposing an adhesive layer on a first substrate, the adhesive layer comprising a first adhesive region comprising a first colorant and a first adhesive and a second adhesive region comprising a second adhesive, wherein the first adhesive has a first adhesion value to the first substrate and the second adhesive has a second adhesion value to the first substrate different from the first adhesion value.

17. A method according to claim 12 wherein the disposing step comprises screen printing or ink jet printing the adhesive layer on the first substrate.

18. A method according to claim 13 wherein the applying step comprises screen printing or ink jet printing the adhesive layer on the release liner.

19. A method according to claim 12 further comprising curing the first adhesive region or the second adhesive region.

20. A method of using an article comprising steps of:
providing an adhesive laminate comprising an adhesive layer disposed on a first substrate, the adhesive layer comprising a first adhesive region comprising a first adhesive and a second adhesive region comprising a second adhesive, wherein the first adhesive is different from the second adhesive and the first adhesive region forms an indicia;
applying the adhesive laminate to a second substrate such that the adhesive layer is positioned between the first substrate and the second substrate; and
separating at least a portion of the first substrate from at least a portion of the second substrate, wherein the separating provides a tamper evident feature.

21. A method according to claim 20 wherein the providing step comprises providing an adhesive laminate comprising an adhesive layer disposed on a first substrate, the adhesive layer comprising a first adhesive region comprising a first adhesive and a second adhesive region comprising a second adhesive, wherein the first adhesive has a first adhesion value to the first substrate and the second adhesive has a second adhesion value to the first substrate different than the first adhesion value and wherein the applying step comprises applying the adhesive laminate adhesive layer to a second substrate and the first substrate is different from the second substrate.

22. A method according to claim 21 wherein the separating step comprises separating at least a portion of the first substrate from at least a portion of the second substrate and at least a portion of the first adhesive region remains adhered to the first substrate and at least a portion of the second adhesive region remains adhered to the second substrate.

23. A method according to claim 21 wherein the separating step comprises separating at least a portion of the first substrate from at least a portion of the second substrate and at least a portion of the first adhesive region remains adhered to the first substrate and at least a portion of the second adhesive region remains adhered to the first substrate and the second substrate.
